(19) United States
(12) Patent Application Publication
(10) Pub. No.: US 2024/0160892 A1
(43) Pub. Date: May 16, 2024

(54) METHOD AND SYSTEM FOR SELECTING AN ARTIFICIAL INTELLIGENCE (AI) MODEL IN NEURAL ARCHITECTURE SEARCH (NAS)

(71) Applicant: samsung electronics co., ltd., Suwon-si (KR)

(72) Inventors: Prateek KESERWANI, Bengaluru (IN); Srinivas Soumitri MIRIYALA, Bengaluru (IN); Vikram Nelvoy RAJENDIRAN, Bengaluru (IN); Pradeep NELAHONNE SHIVAMURTHAPPA, Bangaluru (IN)

(73) Assignee: SAMSUNG ELECTRONICS CO., LTD., Suwon-si (KR)

(21) Appl. No.: 18/414,068

(22) Filed: Jan. 16, 2024

Related U.S. Application Data
(63) Continuation of application No. PCT/KR23/95066, filed on Oct. 23, 2023.

(30) Foreign Application Priority Data
Oct. 25, 2022 (IN) 2022411060811
May 29, 2023 (IN) 20241060811

(51) Int. Cl. G06N 3/04

(52) U.S. Cl. CPC G06N 3/04

(57) ABSTRACT

A method for selecting an artificial intelligence (AI) model in neural architecture search, includes: measuring a scale of receptive field for a plurality of neural network layers corresponding to each of a plurality of candidate AI models; determining a first score for a first group of neural network layers among the plurality of neural network layers based on the scale of the receptive field for the first group of neural network layers, the scale of the receptive field for each of the first group of neural network layers being smaller than a size of an object; determining a second score for a second group of neural network layers among the plurality of neural network layers based on the scale of the receptive field for the second group of neural network layers, the scale of the receptive field for each of the second group of neural network layers being greater than the size of the object; determining a third score for each of the plurality of candidate AI models as a function of the first score and the second score; and selecting, based on the third score, a candidate AI model among the plurality of candidate AI models for training and deployment, the candidate AI model having a highest third score among the third scores of the plurality of candidate AI models.

### CROSS-REFERENCE TO RELATED APPLICATIONS

This application is a Bypass Continuation Application of International Application No. PCT/KR2023/095066, filed on Oct. 25, 2023, which is based on and claims priority to Indian Patent Application No. 202241060811, filed on Oct. 25, 2022 in the Indian Intellectual Property Office, and to Indian Patent Application No. 202241060811 filed on May 29, 2023 in the Indian Intellectual Property Office, the disclosures of which are incorporated by reference herein in their entireties.

### BACKGROUND

### 1. Field

The disclosure generally relates to the field of neural networks, and more particular, to a method and a system for selecting an artificial intelligence (AI) model in neural architecture search (NAS).

### 2. Description of Related Art

With advancements of artificial intelligence technologies, overall design of neural network structures is shifting from manual to automatic machine design. Developers can be assisted in finding an ideal neural network architecture by using neural architecture search (NAS). The NAS is a technique for automating the building of neural networks (NN) such as artificial neural networks (ANN) and deep neural networks (DNN), a popular model in machine learning. The NAS has been used to design networks that are on par with or outperform hand-designed architectures. Even though NAS is able to design tailored NNs effectively, there is still a major challenge with current NAS approaches. i.e., NAS is very compute-intensive and time-consuming. Current NAS approaches simply try out a plurality of NN models/designs and select one of the plurality of NNs. FIG. 1 illustrates a related art NAS approach 100. As shown in FIG. 1, a plurality of NN models/designs 101, and 103 are trained (block 105). Then, each of the trained NN models is tested on unseen data (block 107). If the testing is successful (block 109), then the NN model is deployed (block 111). Otherwise, a new NN model is selected and again trained and tested with unseen data. In some related art NAS approaches, the plurality of NNs is trained repetitively until a final validation accuracy is computed and used to compare NNs to each other and select the best one. However, this is time-consuming because training takes multiple hours/days/weeks as the search space is very large and several days/weeks are needed to find an optimal NN model/design. Further, training during design increases dependency on the NN Model. Also, the related art NAS approach requires exorbitant memory and results in power consumption and latency.

Few solutions have been provided to solve the above discussed problems. One of the solutions is to use a proxy method to speed up the NAS. The proxy method is a reduced form of training where the number of training is reduced, a smaller NN model is used, and/or the training data is subsampled. One of the proxy method is “zero-cost” proxy method, which is a way to estimate the performance of NN model without training. FIG. 2 illustrates a block diagram 200 of NAS with a “zero-cost” proxy, in accordance with the related art. As shown in FIG. 2, an NAS processor generates the neural network (block 201) and the zero-cost proxies compute the score without detailed training (block 203). Based on a zero-cost score, the model is trained (block 205). In the related art, the training takes several days usually 1-5 days for a single model. However, using the “zero-cost” proxy model, the training takes lesser time, and only limited NNs are trained. Typically, only a single NN is trained. After training, the best model may be deployed (block 207). For example, an NAS processor may generate a plurality of NN models and may apply related art one or more zero-cost proxies such as Single-shot network pruning based on connection sensitivity (SNIP), Gradient Signal Preservation (GraSP), Iterative Synaptic Flow Pruning (SynFlow), and Fisher on the generated NN models. Then, each of the NN models may be ranked based on the zero-cost scores computed by zero-cost proxy. However, related art zero-cost proxies assigned equal weightage to all computation nodes (kernel) of the NN model. For example, each NN model may comprise a plurality of layers such as three layers. Each layer may have corresponding trainable weights such as w1, w2, and w3. To compute a score for the NN model, the zero proxies first calculate loss gradient at each layer based on the corresponding weights and then adds them to get a final score. For example, the NAS processor may calculate the final score for the NN model using below equation:

$$Score = s ( w 1 , \frac{\partial ℒ}{\partial w 1} . ) + s ( w 2 , \frac{\partial ℒ}{\partial w 2} . ) + s ( w 3 , \frac{\partial ℒ}{\partial w 3} . ) \qquad ( 1 )$$

Where loss with respect to weight (wi) is denoted by

$$\frac{\partial ℒ}{\partial wi} .$$

Each layer is assigned the same weight, but each layer may have a different receptive field. Therefore, assigning the same weight to each layer results in an inappropriate score and the best model may not be selected.

### SUMMARY

Provided are a method and a system for selecting an artificial intelligence (AI) model in neural architecture search (NAS).

This summary is provided to introduce a selection of concepts in a simplified format that are further described in the detailed description of the disclosure. This summary is not intended to identify key or essential concepts of the disclosure, nor is it intended for determining the scope of the disclosure.

According to an aspect of the disclosure, a method for selecting an artificial intelligence (AI) model in neural architecture search (NAS), may include: measuring a scale of receptive field for a plurality of neural network layers corresponding to each of a plurality of candidate AI models; determining a first score for a first group of neural network layers among the plurality of neural network layers based on the scale of the receptive field for the first group of neural network layers, the scale of the receptive field for each of the first group of neural network layers being smaller than a size of an object; determining a second score for a second group of neural network layers among the plurality of neural network layers based on the scale of the receptive field for the second group of neural network layers, the scale of the receptive field for each of the second group of neural network layers being greater than the size of the object; determining a third score for each of the plurality of candidate AI models as a function of the first score and the second score; and selecting, based on the third score, a candidate AI model among the plurality of candidate AI models for training and deployment, the candidate AI model having a highest third score among the third scores of the plurality of candidate AI models.

The second group of neural network layers may have a depth that is greater than a depth of the first group of neural network layers.

The determining the first score may include: determining a first weightage value associated with each layer of the first group of neural network layers based on the scale of the receptive field for the first group of neural network layers; and determining the first score based on the first weightage value.

The determining the second score may include: determining a second weightage value associated with each layer of the second group of neural network layers based on the scale of the receptive field for the second group of neural network layers; and determining the second score based on the second weightage value.

The first score corresponds to a sum of a first group of scores corresponding to the first group of neural network layers.

The second score corresponds to a sum of a second group of scores corresponding to the second group of neural network layers.

The measuring the scale of the receptive field for the plurality of neural network layers may include adding information including the scale of the receptive field of the candidate AI model in a feature map.

Each of the plurality of candidate AI models may be a zero-cost proxy model.

The plurality of candidate AI models may be generated by an NAS controller.

According to an aspect of the disclosure, a system for selecting an artificial intelligence (AI) model in neural architecture search (NAS), includes: a memory storing instructions; and at least one processor operatively connected to the memory and configured to execute the instructions to: measure a scale of receptive field for a plurality of neural network layers corresponding to each of a plurality of candidate AI models; determine a first score for a first group of neural network layers among the plurality of neural network layers based on the scale of the receptive field for the first group of neural network layers, the scale of the receptive field for each of the first group of neural network layers being smaller than a size of an object, determine a second score for a second group of neural network layers among the plurality of neural network layers based on the scale of the receptive field for the second group of neural network layers, the scale of the receptive field for each of the second group of neural network layers being greater than the size of the object, determine a third score for each of the plurality of candidate AI models as a function of the first score and the second score, and select, based on the third score, a candidate AI model among the plurality of candidate AI models for training and deployment, the candidate AI model having a highest third score among the third scores of the plurality of candidate AI models.

The second group of neural network layers may have a depth that is greater than a depth of the first group of neural network layers.

The at least one processor may be further configured to execute the instructions to determine the first score by: determining a first weightage value associated with each layer of the first group of neural network layers based on the scale of the receptive field for the first group of neural network layers; and determining the first score based on the first weightage value.

The at least one processor may be further configured to execute the instructions to determine the second score by: determining a second weightage value associated with each layer of the second group of neural network layers based on the scale of the receptive field for the second group of neural network layers; and determining the second score based on the second weightage value.

The at least one processor may be further configured to execute the instructions to determine the first score by performing a summing operation on a first group of scores corresponding to the first group of neural network layers.

The at least one processor may be further configured to execute the instructions to determine the second score by performing a summing operation on a second group of scores corresponding to the second group of neural network layers.

The at least one processor may be further configured to execute the instructions to measure the scale of the receptive field for the plurality of neural network layers by adding information including the scale of the receptive field of the candidate AI model in a feature map.

Each of the plurality of candidate AI models may be a zero-cost proxy model.

The at least one processor may include a NAS controller configured to generate the plurality of candidate AI models.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a related art NAS approach;

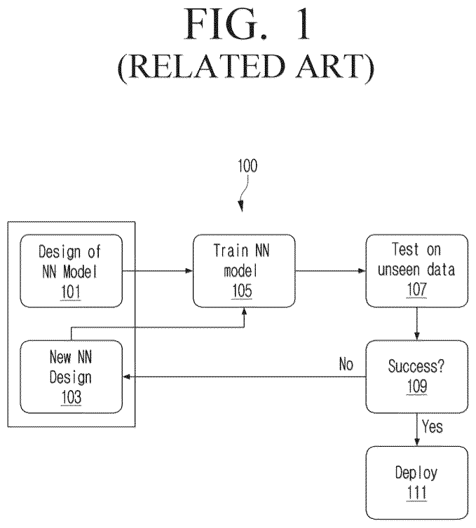

FIG. 2 illustrates a related art NAS approach with zero-cost proxy;

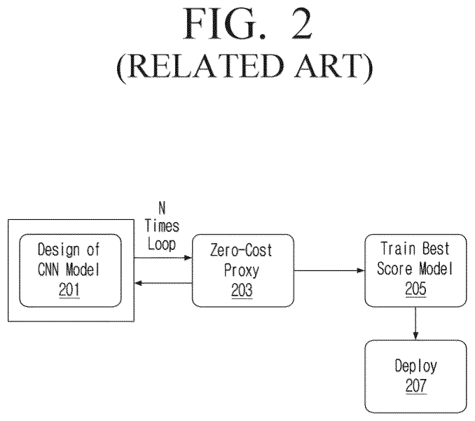

FIG. 3 illustrates a flowchart depicting a method for selecting an artificial intelligence (AI) model in neural architecture search (NAS), in accordance with an embodiment of the disclosure;

FIG. 4 illustrates a block diagram of a system for selecting an artificial intelligence (AI) model in neural architecture search (NAS), in accordance with an embodiment of the disclosure;

FIG. 5A illustrates an example receptive field in a simple neural network, in accordance with an embodiment of the disclosure;

FIG. 5B illustrates an example receptive field in a simple neural network, in accordance with an embodiment of the disclosure;

FIG. 5C illustrates an example receptive field in a simple neural network, in accordance with an embodiment of the disclosure;

FIG. 6 illustrates an example receptive field in a convolutional neural network, in accordance with an embodiment of the disclosure;

FIG. 7 illustrates an example NN model with plurality of NN layers and corresponding receptive field, in accordance with an embodiment of the disclosure;

FIG. 8A illustrates a weightage function, in accordance with an embodiment of the disclosure;

FIG. 8B illustrates a weightage function, in accordance with an embodiment of the disclosure;

FIG. 8C illustrates a weightage function, in accordance with an embodiment of the disclosure; and

FIG. 9 illustrates a comparison between the weightage value assigned to NN layers in the related art and the present disclosure, in accordance with an embodiment of the disclosure.

### DETAILED DESCRIPTION

Example embodiments of the disclosure are described below with reference to the drawings. It be understood that no limitation of the scope of the disclosure is thereby intended, such alterations and further modifications in the disclosed embodiments, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof. Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, “includes”, “including”, or any other variations thereof, are intended to cover a non-exclusive inclusion, such that a process or method that comprises a list of steps does not include only those steps but may include other steps not expressly listed or inherent to such process or method. Similarly, one or more systems or sub-systems or elements or structures or components proceeded by “comprises . . . a” does not, without more constraints, preclude the existence of other systems or other sub-systems or other elements or other structures or other components or additional systems or additional sub-systems or additional elements or additional structures or additional components.

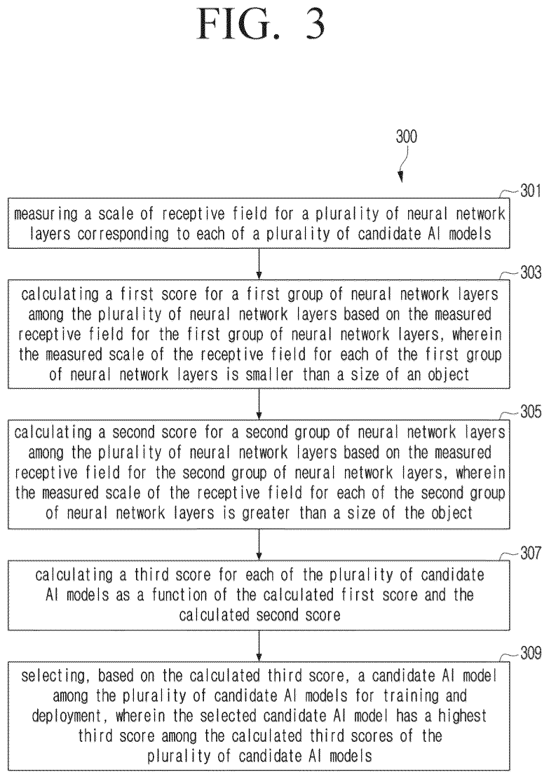

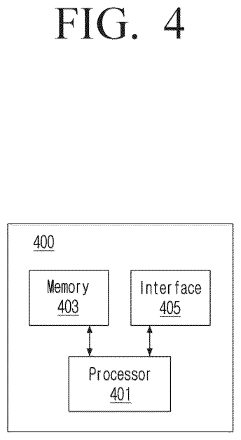

FIG. 3 illustrates a flowchart depicting a method for selecting an artificial intelligence (AI) model in neural architecture search (NAS). FIG. 4 illustrates a block diagram of a system for selecting an artificial intelligence (AI) model in neural architecture search (NAS), in accordance with an embodiment of the disclosure. For the sake of brevity, the description of FIGS. 3 and 4 are explained in conjunction with each other.

As shown in FIG. 4, the system 400 may include but is not limited to, a processor 401, a memory 403, and an interface 405. The processor 401 may be coupled to the memory 403 and the interface 405. The interface 405 may be used to transmit or receive signals/information from or to the system 400.

The processor 401 can be a single processing unit or several units, all of which could include multiple computing units. The processor 401 may be implemented as one processor or a plurality of microprocessors, microcomputers, microprocessors, digital signal processors, central processing units, state machines, logic circuitries, and/or any devices that manipulate signals based on operational instructions. Among other capabilities, the processor 401 is configured to fetch and execute computer-readable instructions and data stored in memory 403.

The memory 403 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an embodiment, the system 400 may be a part of an electronic device. In another embodiment, the system 400 may be coupled to the electronic device. It should be noted that the term “electronic device” refers to any electronic devices used by a user such as a mobile device, a desktop, a laptop, a personal digital assistant (PDA) or similar devices.

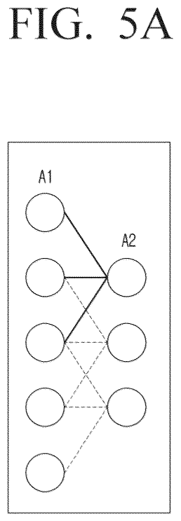

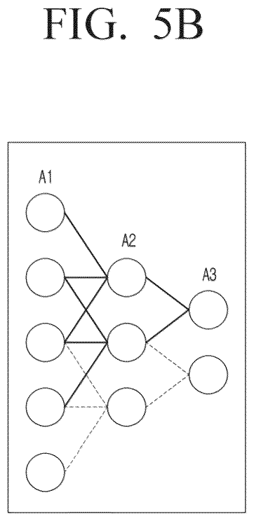

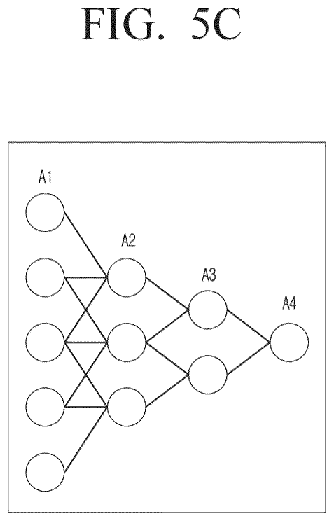

Referring to FIG. 3, at operation 301, the method 300 may comprise measuring a scale of receptive field for a plurality of neural network layers corresponding to each of a plurality of candidate AI models. It should be noted that each of the plurality of candidate AI models is a zero-cost proxy model and may be generated by an NAS controller. In an embodiment, the NAS controller may refer to the processor 401. It should be noted that the receptive field may be defined as a defined segmented area that is occupied by the content of input data that a neuron within a convolutional layer of the NN is exposed to during the process of convolution. In an embodiment, the processor 401 may measure the scale of the receptive field for each of the NN layers based on a number of neurons of an input layer being connected to a single neuron of that layer. For example, as shown in FIG. 5A, the scale of the receptive field for A2 layer is 3 as a single neuron on A2 is connected with three neurons on A1. Similarly, as shown in FIG. 5B, the scale of the receptive field for A3 layer is 4 as a single neuron on A3 is connected with two neurons on A2, and a single neuron on A2 is connected to A1 is 3. Similarly, as shown in FIG. 5C, the scale of the receptive field for A4 layer is 5 as a single neuron on A4 is connected with two neurons on A3, while a single neuron on A3 is connected with two neurons on A2 and single neuron on A2 is connected to A1 is 3. Hence, it can be seen that the receptive field of a deeper layer, i.e., A3 is greater that the receptive field of earlier layers, i.e., A1 and A2.

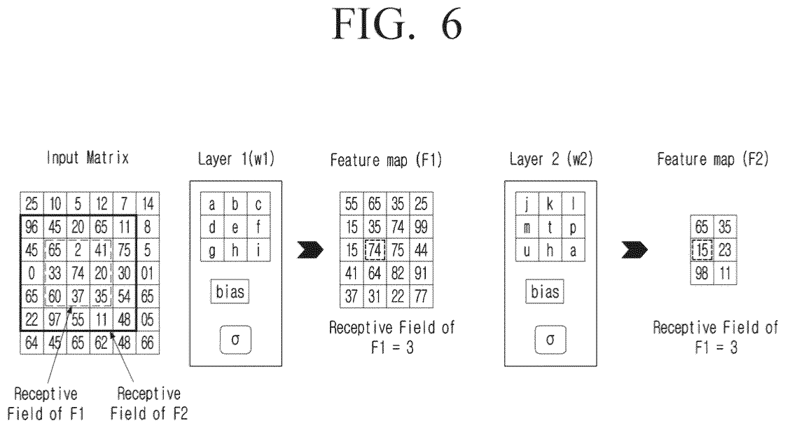

In another embodiment, the processor 401 may measure the scale of the receptive field for each of the NN layers based on a feature map of that layer. For example, as shown in FIG. 6, the layer 1 has covered 3×3 region of the input, hence receptive field is 3 for layer 1. A single value in the feature map F1 comes due to the coverage of 3×3 area in an input. Similarly, the layer 2 is covering the 3×3 area of a feature map F1, and a single value in F1 is comes from 3×3 area of an input, hence, the layer 2 has covered the 5×5 area of an input. Hence, the receptive field of the layer 2 is 5, and a single value at F2 covers 5×5 area of an input. Accordingly, in an embodiment, the processor 401 may measure the scale of the receptive field by adding information such as the measured scale of the receptive field of the selected candidate AI model in a feature map. Further, it can be seen from FIGS. 5A-6 that the receptive field of a deeper layer, i.e., layer 2 is greater than the receptive field of an earlier layer, i.e., layer 1. The reason being a smaller receptive field causes a response based on a small region of input and as the layers are stacked, the receptive field increases, thereby increasing the region of input. Hence, if a weight value is assigned to each layer based on the measured receptive field, then a better score for each of the AI models can be determined.

Further, it should be noted that FIGS. 5A-6 only illustrate a few examples of measuring the receptive field of the NN model. Any other method may be used to measure the receptive field of the NN model and any such method shall be considered within the scope of the disclosure.

Referring back to FIG. 3, at operation 303, the method 300 may comprise determining a first score for a first group of neural network layers among the plurality of neural network layers based on the measured receptive field for the first group of neural network layers. In an embodiment, the measured scale of the receptive field for each of the first group of neural network layers is smaller than a size of an object. In an embodiment, the object may refer to any area of interest of an image, text, audio, video, etc.

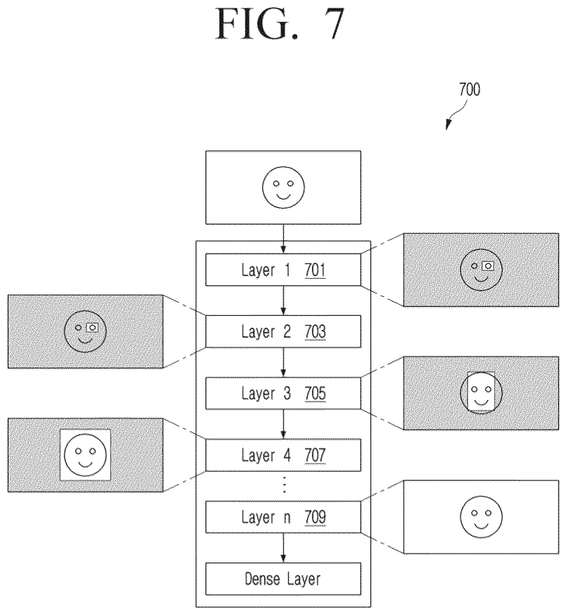

At operation 305, the method 300 may comprise determining a second score for a second group of neural network layers among the plurality of neural network layers based on the measured receptive field for the second group of neural network layers. In an embodiment, the measured scale of the receptive field for each of the second group of neural network layers is greater than the size of the object. Operations 303 and 305 are further explained in reference to FIG. 7. FIG. 7 illustrates an example NN model with a plurality of NN layers and corresponding receptive field, in accordance with an embodiment of the disclosure. As shown in FIG. 7, the NN model 700 may include a first group of NN layers (701, 703, 705, 707) and a second group of NN layers (709). As can be seen from FIG. 7, the receptive field of each of the first group of NN layers is smaller than the size of the object and the receptive field for each of the second group of neural network layers is greater than the size of the object.

In an embodiment, the second group of neural network layers (709) have a depth greater than a depth of the first group of neural network layers (701-707), as shown in FIG. 7. Further, the first score is determined based on a first weightage value associated with each layer of the first group of neural network layers. The first weightage value is determined based on the measured receptive field for the first plurality of neural network layers. Similarly, the second score is determined based on a second weightage value associated with each layer of the second group of neural network layers. The second weightage value is determined based on the measured receptive field for the second plurality of neural network layers. For example, as shown in FIG. 7, the receptive field for layer1 701 is very small and a high first weightage value to small regions will include noise in the computation of the first score. Hence, a small weightage value should be assigned to layer1 701. Similarly, the receptive field for layer3 705 is large enough to cover the important regions. Hence, the first weightage value should be larger. For the second group of layers, as shown in FIG. 7, the receptive field for layer 709 covers the huge background region. Hence, a high first weightage value should be assigned to rectify the impact of the background.

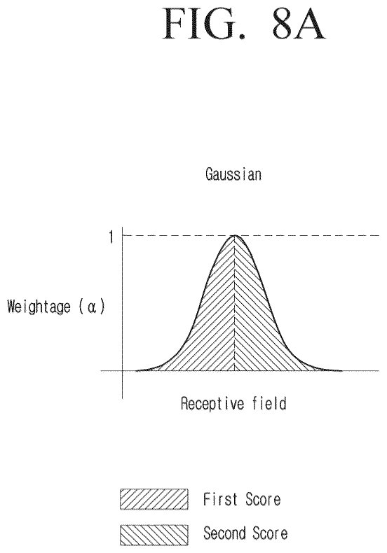

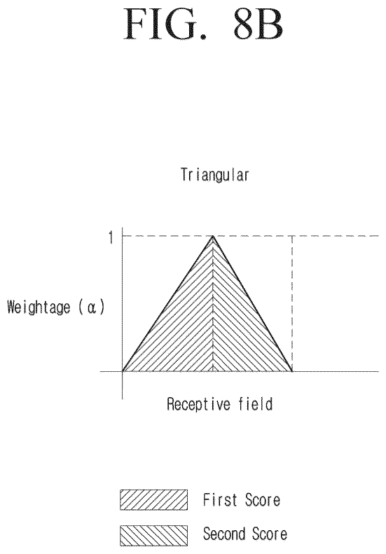

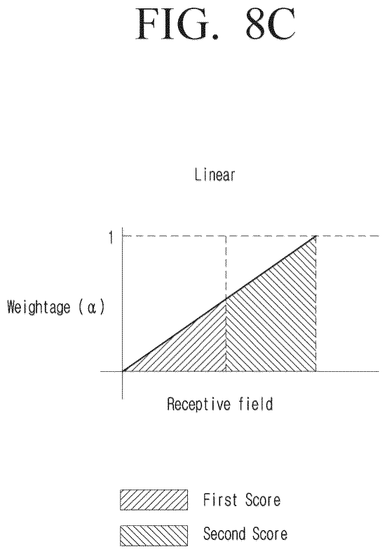

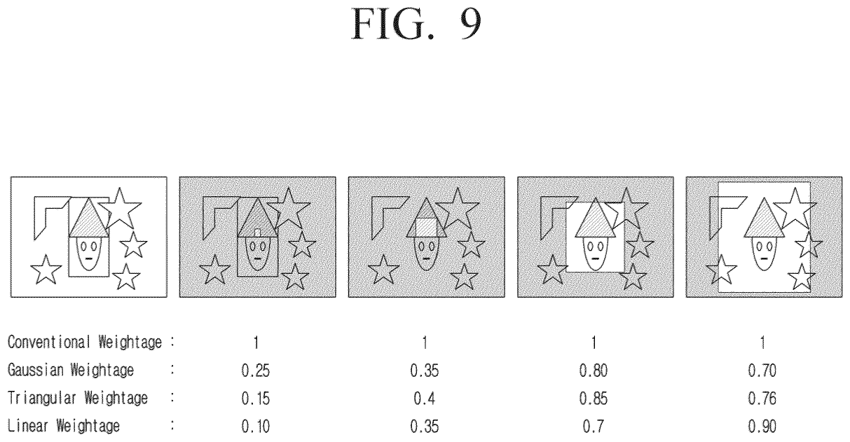

Further, in an embodiment, the first and the second weightage value may be determined using one of a plurality of weightage functions. In an embodiment, the plurality of weightage functions may include a Gaussian weightage function, a triangular weightage function, and a linear weightage function. FIGS. 8A-8C illustrate various weightage functions, in accordance with an embodiment of the disclosure. As shown in FIGS. 8A-8C, a maximum value of 1 may be assigned as the first and the second weightage value. If the receptive field is equal to the object size, then the maximum value of 1 is assigned as the first and the second weightage value. However, the first and the second weightage value decrease with the further increase in the receptive field. FIG. 9 illustrates a comparison between the weightage value assigned to NN layers in the related art and the disclosure, in accordance with an embodiment of the disclosure. As shown in FIG. 9, in an embodiment, the weightage value is assigned based on the receptive field of the NN layer. Whereas, in the related art, the same value, i.e., 1 is assigned irrespective of the receptive field of the NN layer. Accordingly, the first score may be calculated as:

$$First score = {\sum }_{i = 1}^{n} α is ( wi , \frac{\partial ℒ}{\partial wi} ) \qquad ( 2 )$$

Wherein αi is the first weightage value for each of the NN layers of the first group and wi is the corresponding weight of each of the NN layers of the first group.

Hence, the first score corresponds to a sum of a first group of scores corresponding to the first group of neural network layers.

Similarly, the second score may be calculated as:

$$Second score = {\sum }_{j = 1}^{m} α js ( wj , \frac{\partial ℒ}{\partial wj} ) \qquad ( 3 )$$

Wherein αj is the second weightage value for each of the NN layers of the second group and wj is the corresponding weight of each of the NN layers of the second group.

Hence, the second score corresponds to a sum of a second group of scores corresponding to the second group of neural network layers.

Referring back to FIG. 3, at operation 307, the method 300 may comprise calculating a third score for each of the plurality of candidate AI models as a function of the calculated first score and the calculated second score. For example, in an embodiment, the third score may be calculated as a summation of the first score and the score as shown in below equation:

$$Third score = {\sum }_{i = 1}^{n} α is ( wi , \frac{\partial ℒ}{\partial wi} ) + {\sum }_{j = 1}^{m} α js ( wj , \frac{\partial ℒ}{\partial wj} ) \qquad ( 4 )$$

In another embodiment, a value of a classifier may also be added to compute the third score.

Thereafter, at operation 309, the method 300 may comprise selecting, based on the calculated third score, a candidate AI model among the plurality of candidate AI models for training and deployment, wherein the selected candidate AI model has a highest third score among the calculated third scores of the plurality of candidate AI models. In particular, the third score is calculated for each of the candidate AI model and the candidate AI model with the highest third score is selected for training and deployment on the electronic device.

Hence, the present disclosure considers the perception window of each neuron of the NN layer and uses this wisely in the formulation of a more understandable and reliable zero-cost proxy. Further, the significance of the receptive field is mathematically transformed into weights on individual metrics obtained from each layer.

Accordingly, the present disclosure provides the following technical advantages:
The present disclosure results in saving a significant amount of load and computations.
The present disclosure provides faster response by the AI models compared to the state of the related art.
The present disclosure results in a reduction in expert intervention and time consumed for finding an optimal AI model.
The present disclosure provides a faster personalization effect to end users, as these AI models would further get trained as part of on-device learning.
The present disclosure provides accuracy-preserving pruning that yields similar quality results with significantly lower space and time requirements.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While the disclosure has been particularly shown and described with reference to embodiments thereof, it will be understood that various changes in form and details may be made therein without departing from the spirit and scope of the following claims.

What is claimed is:

1. A method for selecting an artificial intelligence (AI) model in neural architecture search (NAS), the method comprising:
measuring a scale of receptive field for a plurality of neural network layers corresponding to each of a plurality of candidate AI models;
determining a first score for a first group of neural network layers among the plurality of neural network layers based on the scale of the receptive field for the first group of neural network layers, the scale of the receptive field for each of the first group of neural network layers being smaller than a size of an object;
determining a second score for a second group of neural network layers among the plurality of neural network layers based on the scale of the receptive field for the second group of neural network layers, the scale of the receptive field for each of the second group of neural network layers being greater than the size of the object;
determining a third score for each of the plurality of candidate AI models as a function of the first score and the second score; and
selecting, based on the third score, a candidate AI model among the plurality of candidate AI models for training and deployment, the candidate AI model having a highest third score among the third scores of the plurality of candidate AI models.

2. The method as claimed in claim 1, wherein the second group of neural network layers have a depth that is greater than a depth of the first group of neural network layers.

3. The method as claimed in claim 1, wherein the determining the first score comprises:
determining a first weightage value associated with each layer of the first group of neural network layers based on the scale of the receptive field for the first group of neural network layers; and
determining the first score based on the first weightage value.

4. The method as claimed in claim 1, wherein the determining the second score comprises:
determining a second weightage value associated with each layer of the second group of neural network layers based on the scale of the receptive field for the second group of neural network layers; and
determining the second score based on the second weightage value.

5. The method as claimed in claim 1, wherein the first score corresponds to a sum of a first group of scores corresponding to the first group of neural network layers.

6. The method as claimed in claim 1, wherein the second score corresponds to a sum of a second group of scores corresponding to the second group of neural network layers.

7. The method as claimed in claim 1, wherein the measuring the scale of the receptive field for the plurality of neural network layers comprises:
adding information including the scale of the receptive field of the candidate AI model in a feature map.

8. The method as claimed in claim 1, wherein each of the plurality of candidate AI models is a zero-cost proxy model.

9. The method as claimed in claim 1, wherein the plurality of candidate AI models are generated by an NAS controller.

10. A system for selecting an artificial intelligence (AI) model in neural architecture search (NAS), the system comprising:
a memory storing instructions; and
at least one processor operatively connected to the memory and configured to execute the instructions to:
measure a scale of receptive field for a plurality of neural network layers corresponding to each of a plurality of candidate AI models;
determine a first score for a first group of neural network layers among the plurality of neural network layers based on the scale of the receptive field for the first group of neural network layers, the scale of the receptive field for each of the first group of neural network layers being smaller than a size of an object,
determine a second score for a second group of neural network layers among the plurality of neural network layers based on the scale of the receptive field for the second group of neural network layers, the scale of the receptive field for each of the second group of neural network layers being greater than the size of the object,
determine a third score for each of the plurality of candidate AI models as a function of the first score and the second score, and
select, based on the third score, a candidate AI model among the plurality of candidate AI models for training and deployment, the candidate AI model having a highest third score among the third scores of the plurality of candidate AI models.

11. The system as claimed in claim 10, wherein the second group of neural network layers have a depth that is greater than a depth of the first group of neural network layers.

12. The system as claimed in claim 10, wherein the at least one processor is further configured to execute the instructions to determine the first score by:
determining a first weightage value associated with each layer of the first group of neural network layers based on the scale of the receptive field for the first group of neural network layers; and
determining the first score based on the first weightage value.

13. The system as claimed in claim 10, wherein the at least one processor is further configured to execute the instructions to determine the second score by:
determining a second weightage value associated with each layer of the second group of neural network layers based on the scale of the receptive field for the second group of neural network layers; and
determining the second score based on the second weightage value.

14. The system as claimed in claim 10, wherein the at least one processor is further configured to execute the instructions to determine the first score by performing a summing operation on a first group of scores corresponding to the first group of neural network layers.

15. The system as claimed in claim 10, wherein the at least one processor is further configured to execute the instructions to determine the second score by performing a summing operation on a second group of scores corresponding to the second group of neural network layers.

16. The system as claimed in claim 10, wherein the at least one processor is further configured to execute the instructions to measure the scale of the receptive field for the plurality of neural network layers by adding information including the scale of the receptive field of the candidate AI model in a feature map.

17. The system as claimed in claim 10, wherein each of the plurality of candidate AI models is a zero-cost proxy model.

18. The system as claimed in claim 10, wherein the at least one processor comprises a NAS controller configured to generate the plurality of candidate AI models.
